(19) United States
(12) Patent Application Publication
(10) Pub. No.: US 2026/0049514 A1
(43) Pub. Date: Feb. 19, 2026

(54) FIXTURE FOR MOUNTING A WINDOW LIFTER ASSEMBLY IN A VEHICLE DOOR

(71) Applicant: Brose Fahrzeugteile SE & Co. KG, Bamberg, Bamberg (DE)

(72) Inventors: Shane Alexander, Ortonville, MI (US); Chase Reames, Fenten, MI (US)

(21) Appl. No.: 19/188,759

(22) Filed: Apr. 24, 2025

(30) Foreign Application Priority Data
Apr. 24, 2024 (DE) 10 2024 111 550.5

(51) Int. Cl. E05F 11/38

(52) U.S. Cl. CPC E05F 11/382; E05Y 2600/12; E05Y 2600/46; E05Y 2600/626; E05Y 2900/55

(57) ABSTRACT

It is provided a fixture for mounting a window lifter assembly in a vehicle door, wherein the fixture can be mounted in a vehicle door and at least includes at least one mounting portion, via which the window lifter assembly can be mounted on the fixture in a plurality of mounting positions, and at least one tool interface, via which a tool adapted for connection can reversibly be connected to the fixture, wherein the window lifter assembly properly mounted on the fixture can be shifted from one of the mounting positions into another one of the mounting positions by a torque introduced into the connected tool. adjusting

### CROSS REFERENCE TO RELATED APPLICATION

The present application claims priority to German Patent Application No. 10 2024 111 550.5 filed on Apr. 24, 2024. The entire contents of the above-listed application are hereby incorporated by reference for all purposes.

### BACKGROUND

The proposed solution relates to a fixture for mounting a window lifter assembly in a vehicle door.

Window lifter assemblies are known in principle from the automotive industry. Window lifter assemblies in general comprise at least one rail on which a driver is guided, which can be adjusted in a power-operated or manual way. The driver is connected to the window pane in order to adjust the same. Thus, in the state properly mounted in a vehicle door, window lifter assemblies provide for opening and closing vehicle windows in a power-operated or manual way. For the closed window pane to ensure a reliable and low-noise sealing, window lifter assemblies must be adjustable precisely with respect to their position within the vehicle door. A precise adjustment in particular is of special importance in frameless vehicle doors. In the closed state, the window pane here seals directly with the body of the vehicle. When the window pane is adjusted insufficiently, vibrations of the window pane can occur in operation of the vehicle beside an air exchange with a vehicle interior and thus a production of undesired noise can occur.

In principle it is known that window lifter assemblies can be integrated in vehicle doors in such a way that a mounting position of the window lifter assembly can be adapted during the assembly or a subsequent maintenance, in order to ensure a reliable sealing. This can render the structure of a vehicle door more complex and thus more cost-intensive. Furthermore, a subsequent adjustment of a window lifter assembly mounted already can require a proportional disassembly of the vehicle door.

### SUMMARY

Therefore, it is necessary to further improve an adjustability of window lifter assemblies.

This object is achieved with the proposed fixture for mounting a window lifter assembly in a vehicle door with features as described herein.

The proposed fixture can be mounted in a vehicle door and at least includes:
at least one mounting portion via which the window lifter assembly can be mounted on the fixture in a plurality of mounting positions, and
at least one tool interface, via which a tool adapted for connection can reversibly be connected to the fixture, wherein the window lifter assembly properly mounted on the fixture can be shifted from one of the mounting positions into another one of the mounting positions by a torque introduced into the connected tool.

The fixture allows that a correspondingly adapted tool is connected to the fixture in such a way that a torque introduced into the tool is translated into an adjusting force. The adjusting force is introduced into a window lifter assembly properly connected to the fixture, so that the window lifter assembly can thereby be shifted between various mounting positions. By choosing the mounting positions, the window lifter assembly thus can be adjusted relative to the fixture and, in the mounted state, relative to the vehicle door. The fixture accordingly can be mounted in a vehicle door, so that the window lifter assembly can adjustably be integrated in the vehicle door. The proposed fixture allows to release the window lifter assembly in the mounted state, shift it from one mounting position into another one and fix it again. The release of the window lifter assembly can also refer to a partial release, which however does not provide for a disassembly, but for shifting of the window lifter assembly. The door body, in particular the door inner skin and the door outer skin, need not provide any special fixture portions which define a plurality of mounting positions for the window lifter assembly. This can reduce the production costs for a vehicle door.

By providing a tool interface, the adjustment of the window lifter assembly can also be possible and conceivable over a larger distance so that no direct access to the proposed fixture is necessary in order to adjust the mounted window lifter assembly. In particular, it thus is conceivable and possible that the window lifter assembly is adjustable with a mounted interior door trim. This can reduce a mounting expenditure and maintenance expenditure of a vehicle door mounted with the proposed fixture. In particular in frameless vehicle doors the adjustment of the window lifter assembly improved in this way can improve the comfort of use for a vehicle user due to reduced sound emissions.

The proposed fixture can include a substantially flat base body. Due to various openings and angled portions, the base body can be adapted for connection to the window lifter assembly and the vehicle door. This can provide for an inexpensive manufacture. By way of example, the fixture can be made of a metallic material or a plastic material.

In particular, the proposed fixture can be mountable on a door module carrier. Such door module carriers can be attached to a door body, for example a door inner skin or a door outer skin, between a wet space and a dry space of a vehicle. The door module carrier can include a carrier plate to which a plurality of different functional elements of a vehicle door, such as a window lifter assembly, a door lock, a door handle, cable strands and an interior door trim can be connected. These functional elements can be combined with the door module carrier to form a pre-mounted, pre-testable assembly (door module), which as a whole can be attached to the door body.

In particular in a pre-mounted state, such a door module can be supplied to a final assembly of a vehicle door and/or a vehicle. In the pre-mounted state, the window lifter assembly properly mounted via the proposed fixture can be present in a preset mounting position. The preset mounting position can be adjusted to the installation in a concrete type of a vehicle door and/or a vehicle. This can reduce an expenditure in the final assembly. In the final assembly, an adjustment of the window lifter assembly thus can only become necessary to adapt the mounting position to possible manufacturing tolerances.

The proposed fixture provides for a modular integration into various vehicle types, in that merely the fixture as an interface between a concrete vehicle door and the window lifter assembly must be adapted to the vehicle type. This can reduce the development costs.

Furthermore, the proposed fixture can specifically stiffen the window lifter assembly and/or the vehicle door and thus increase safety for vehicle occupants in the event of an accident.

By way of example, the at least one mounting portion of the fixture can be formed with a bolt or a screw. For properly mounting the window lifter assembly, the window lifter assembly can include at least one opening. The number of openings of the window lifter assembly can correspond to the number of mounting portions of the fixture. For mounting purposes, the window lifter assembly can be arrangeable on the fixture in such a way that the at least one mounting portion of the fixture extends through the at least one opening of the window lifter assembly. Via a connecting element, such as a screw, the window lifter assembly can be fixable to the mounting portion in one of the mounting positions.

By way of example, the at least one opening of the window lifter assembly can be formed with an oblong hole in order to define a plurality of mounting positions at the fixture.

In another embodiment of the proposed fixture, the at least one mounting portion can be formed with a mounting opening. A connecting element, in particular a screw or a bolt, can be introducible into the at least one mounting opening for mounting the window lifter assembly on the fixture.

According to another embodiment of the proposed fixture, the at least one mounting opening can be formed with an oblong hole. With the mounting opening formed with at least one oblong hole, the fixture thus defines the plurality of mounting positions in which the window lifter assembly can be mounted on the fixture. This can improve an adjustability of a window lifter assembly.

The mounting portion or the tool interface can be adapted for supporting a tool reversibly connected to the fixture.

By way of example, the mounting portion can be adapted for supporting a tool. The tool reversibly connected to the fixture via the tool interface thus can introduce an adjusting force for adjusting the mounted window lifter assembly into the tool interface by a torque introduced into the tool.

What likewise is conceivable and possible is the kinematic reversal. In another embodiment, the proposed fixture accordingly can be formed with at least one tool interface on which a tool can be supported. By introducing a torque into the tool supporting on the tool interface, an adjusting force for adjusting the mounted window lifter assembly accordingly can be introducible into the mounting portion. Due to the adjusting force, the properly mounted window lifter assembly can be shiftable on the fixture from one of the mounting positions into another one of the mounting positions.

According to another embodiment of the proposed fixture, a boundary of the mounting opening can include an opening for pushing the connecting element into the mounting opening. The connecting element thus can be introducible into the mounting opening more easily and more quickly. This can reduce the mounting expenditure.

By way of example, the connecting element can be formed with a screw-nut pairing. In this case, a nut can be loosely pre-mounted with a screw connected to the window lifter assembly and in the pre-mounted state can be introduced into the mounting opening via the opening. Subsequently, the nut can be tightened for fixing a mounting position.

In another embodiment of the proposed solution, the opening can extend up to an edge of the fixture. Accordingly, the edge of the fixture can be pierced by the opening. This can provide for pushing the connecting element from the edge of the fixture into the mounting opening. Thus, the mounting expenditure can be further reducible.

According to another embodiment of the proposed solution, the opening can have a larger minimum expansion than the mounting opening. Accordingly, a broad portion of the connecting element, such as a head of a screw, can fit through the opening, but not through the mounting opening. Thus, the connecting element can be put through the opening and subsequently be pushed onto the mounting opening. This can provide for an easy assembly, without the opening piercing the edge of the fixture. A loadability of the fixture can thereby be improvable.

By way of example, the opening can be formed as a circular opening which is connected to the mounting opening, wherein the opening has a diameter which is at least as large as an outside diameter of a nut or a screw head of the connecting element. The mounting opening on the other hand can have a minimum expansion which is slightly larger than an outside diameter of a thread portion of the connecting element formed as a screw.

According to another embodiment of the proposed fixture, the tool interface can be formed with a protruding or receding structure with respect to the fixture. Thus, a tool adapted therefor can support on the structure in order to introduce a force into the connecting element. Due to this force, the connecting element can be shiftable along the mounting opening.

By way of example, the tool interface can be formed with a trunnion. A trunnion does not necessarily need to have a circular cross-section. Other, e.g. elliptical, cross-sections of the trunnion likewise are conceivable and possible. By way of example, the fixture with an elliptical trunnion can be adapted for a tool to support on the tool interface and to be shiftable along the trunnion. This can improve shifting of the connecting element via the tool.

In another embodiment of the proposed fixture, the tool interface can be formed with an oblong hole. Thus, the tool adapted therefor can engage into the tool interface in a plurality of positions. In each of the positions, the tool can introduce a force suitable for adjusting the connecting element into the connecting element.

By way of example, the tool interface can be formed with a longitudinal axis along which the tool is shiftable in the tool interface. In each of the positions, the tool can each support on the tool interface in order to shift the released connecting element in the mounting opening.

The longitudinal axis of the tool interface can substantially be arranged transversely to a longitudinal axis of the mounting opening. This can improve the support of the tool in each of the positions and thus simplify the shifting of the connecting element.

According to another embodiment of the proposed fixture, the fixture can include at least one connecting opening for connecting the fixture to a door module carrier. Via the connecting opening, the fixture can be connectable to the door module carrier in a defined position.

In principle, mounting of the proposed fixture on the door inner skin and/or the door outer skin also is conceivable and possible. In particular, a connection of the proposed fixture to a plurality of door elements, such as door inner skin and door outer skin and door module carrier, also is conceivable and possible. This can serve to stiffen the vehicle door.

According to an alternative embodiment of the proposed fixture, the same can be weldable or bondable to the door module carrier and/or the door inner skin and/or the door outer skin. Since connecting openings are missing, the fixture can be formed more stiffly.

According to another embodiment of the proposed fixture, the fixture can include at least one holding portion protruding with respect to a flat portion of the fixture for the positive connection of the fixture to a door module carrier. With respect to at least one spatial direction, the fixture thus can be positively connectable to the door module carrier. Thus, the fixture can be adapted to introduce forces which act along this spatial direction into the door module carrier along the aforementioned spatial direction. This can facilitate positioning of the proposed fixture on the door module carrier during an assembly.

By way of example, the holding portion can be formed with an angled region of the fixture, which is adapted to enclose a portion of the door module carrier. It is likewise conceivable and possible that the fixture is formed with a bead which engages into a protrusion or an opening of the door module carrier. This can stiffen the fixture.

According to another embodiment of the proposed solution, the holding portion can be formed to flatly rest against the door module carrier in the state properly mounted on the door module.

In another embodiment of the proposed solution, the proposed fixture can include a fastening portion for fastening functional elements of the vehicle door, such as cable harnesses or Bowden cables. In operation of the vehicle, this can reduce vibrations of the functional elements and thus improve the acoustics and reduce an abrasion shortening the service life.

By way of example, a tool adapted for adjusting a window lifter assembly can at least include:
an outer element and an inner element rotatably mounted within the outer element, wherein
the inner element includes a tool head at an end portion, in particular for releasing a connecting element by a rotation, and a handle at an end portion opposite the tool head, for introducing a torque into the inner element, and
the outer element includes a radially extending supporting portion at an end portion facing the tool head, for reversible connection to a workpiece, and a lever at an end portion facing away from the tool head, for introducing a torque into the outer element.

When the window lifter assembly is shiftably mounted on the proposed fixture, i.e. not fixed completely, and when the tool is reversibly connected to the fixture, the window lifter assembly can be shifted from one mounting position into the other mounting position by means of the aforementioned tool via a torque which is introduced into the inner element.

In dependence on the different conceivable and possible embodiments of the proposed fixture, the tool can support on the fixture on introduction of a torque either via the supporting portion connected to the tool interface or via the tool head arranged on the mounting portion and introduce an adjusting force for shifting the window lifter assembly into the respectively other one of the mounting portion or the supporting portion.

With regard to an embodiment of the proposed fixture in which the mounting portion is formed with a mounting opening, through which a connecting means extends for mounting the window lifter assembly, the connecting element can be released and tightened by means of the tool. This in particular relates to a connecting element which connects a window lifter assembly to a door module carrier. At the same time, the released connecting element can be shifted by means of the tool, in that a torque is introduced into the outer element, while the tool is supported on the tool interface relative to the connecting element via the supporting portion. This provides for an adjustment of a mounting position of a window lifter assembly in the mounted state of the window lifter assembly. In particular, the window lifter assembly thus can be adjusted without first having to remove an interior door trim. This can reduce the mounting and maintenance expenditure during the adjustment of a window lifter assembly. The adjustment merely requires an access for the tool to the connecting element and a point for supporting the tool.

In particular, a window lifter assembly mounted on the proposed fixture can thus be adjusted. The point for supporting the tool is the tool interface of the proposed fixture.

Furthermore by way of example, the supporting portion can be formed with a trunnion. Via the trunnion, the tool thus can engage into a receding tool interface or into a tool interface formed with a hole. In particular, due to the trunnion, the tool can thus be adapted to engage into a tool interface formed with an oblong hole.

The trunnion can extend parallel to a longitudinally extending axis of the inner element. This can improve the support and the introduction of a force for releasing the connecting element and for shifting the connecting element.

The tool head of the tool for adjusting the window lifter assembly mounted on the proposed fixture can be formed with an outer hexagonal profile, an inner hexagonal profile or a Torx profile. In principle, the tool head can also be formed with other head types, which are suitable to produce an operative connection with a connecting element releasable by rotation.

According to another aspect of the proposed solution, the above-mentioned object is also achieved by a vehicle door assembly. The proposed vehicle door assembly at least includes:
a door module carrier,
a fixture of the proposed type, which is mounted on the door module carrier,
a window lifter assembly mounted on the fixture via the at least one mounting portion, and
a door body connected to the door module carrier, comprising at least one adjustment opening for adjusting the mounted window lifter assembly.

According to the proposed vehicle door assembly, the window lifter assembly can be adjusted by choosing the mounting positions relative to the fixture and relative to the vehicle door.

With regard to an embodiment of the proposed fixture, in which the mounting portion is formed with a mounting opening, the at least one connecting element extends through the mounting opening of the proposed fixture and in a released state is shiftable in the mounting opening of the fixture. For adjusting the mounting position, a tool adapted therefor can be guided through the adjustment opening in order to release the at least one connecting element, shift it along the mounting opening, and fix it again. This can reduce a mounting expenditure of the window lifter assembly and/or simplify a subsequent adjustment in connection with maintenance work.

According to another embodiment of the proposed vehicle door assembly, the adjustment opening can be aligned with the at least one mounting portion. Thus, a linear access can exist from the adjustment opening to the mounting portion. This can further simplify an adjustment of the vehicle door assembly.

According to another embodiment of the proposed vehicle door assembly, the adjustment opening can be formed in such a way that a tool as mentioned above can be guided through the door body via the adjustment opening for adjusting the window lifter assembly. In particular, the adjustment opening thus can be large enough for the tool head and the supporting portion of the tool to be guided through the adjustment opening.

An imaginary connection from the adjustment opening to the mounting portion can define a tool channel. Along this tool channel, the tool can be introduced so that the tool head can enter into an operative connection with the mounting portion, in particular the connecting means, and the supporting portion can be reversibly connected to the tool interface. The opposite end portions of the inner and the outer element can protrude from the adjustment opening with the handles arranged thereon. Thus, torques can be introduced into the handles arranged on the tool, and the window lifter assembly can be adjusted without having to remove an interior trim.

According to another embodiment of the proposed solution, the adjustment opening can be sealable in a waterproof way. This can in particular be relevant, as the adjustment opening can represent a connection between a wet space of the vehicle door and a dry space of the vehicle door. By way of example, the adjustment opening can be sealable with a screw cap or a plug.

According to another embodiment of the proposed vehicle door assembly, the fixture of the vehicle door assembly can be an embodiment with an opening for pushing the connecting element into the mounting opening. The opening can be arranged above the mounting opening along a vertical. Accordingly, the connecting element can be insertable into the mounting opening from above along the weight force of the window lifter assembly. This can further simplify the assembly.

In particular, but not exclusively, the proposed vehicle door assembly can relate to a frameless vehicle door.

According to another aspect of the proposed solution, the above-mentioned object is also achieved by a vehicle comprising the proposed vehicle door assembly. Due to the improved adjustability of the window lifter assembly, the sealing of the window pane with a frame of the vehicle door or with a body of the vehicle (in the case of a frameless vehicle door) here can be improved. This can reduce a vibration and/or development of noise and/or entrance of air in operation of the vehicle.

According to another aspect of the proposed solution, the above-mentioned object is also achieved by a mounting method of a vehicle door assembly. The proposed mounting method at least comprises:
mounting the proposed fixture on a door module carrier,
mounting a window lifter assembly on the fixture on the at least one mounting portion of the fixture, and
mounting the door module carrier on a door body with an adjustment opening for adjusting the mounted window lifter assembly.

Due to the proposed mounting method, the vehicle door can be pre-mounted as an assembly. The adjustment of the window lifter assembly in particular in frameless vehicle doors subsequently can be effected after mounting the vehicle door on the body, without trim elements of the vehicle door having to be removed therefor. This can simplify the adjustment of the window lifter assembly and improve the sealing achieved. In particular, a subsequent adjustment of the window lifter assembly during maintenance can be simplified.

According to another aspect of the proposed solution, the above-mentioned object is also achieved with a method for adjusting the window lifter assembly of the proposed vehicle door assembly by means of the tool. The window lifter assembly here initially is detached from the fixture to such an extent that shifting relative to the fixture is possible. Subsequently, the window lifter assembly can be shifted from one mounting position into another mounting position and the window lifter assembly can again be fixed to the fixture.

In particular in one embodiment of the fixture with a mounting opening the at least one connecting element can be released by means of the tool, be shifted along the mounting opening, and be fixed again.

The proposed method for adjusting the window lifter assembly can do without the disassembly of an interior door trim. Merely a possible closure of the adjustment opening must be removed in order to bring the tool into operative connection with the proposed fixture. This can reduce an expenditure of time for the adjustment of the window lifter assembly as well as the costs and improve a sealing achieved with the adjustment.

The above explanations concerning advantages and conceivable embodiments of the proposed fixture analogously apply for the tool, the proposed vehicle door assembly, the proposed vehicle, the proposed mounting method, and the proposed method for adjusting the window lifter assembly.

### BRIEF DESCRIPTION OF THE DRAWINGS

The attached Figures by way of example illustrate possible design variants of the proposed solution.

FIG. 1 shows a perspective representation of a first embodiment of the proposed fixture with a mounting opening and a tool interface.

FIG. 2 shows the proposed fixture of FIG. 1 in a state mounted on a door module carrier with a window lifter assembly mounted on the fixture.

FIGS. 3A, 3B, 3C, 3D show various further embodiments of the proposed fixture.

FIG. 4A shows another embodiment of the proposed fixture with an opening for pushing a connecting element into the mounting opening.

FIG. 4B shows a perspective representation of a mounting position of the fixture of FIG. 4A on a door module carrier.

FIG. 5 shows a perspective representation of possible mounting positions of a window lifter assembly on the proposed fixture of FIG. 4A.

FIG. 6A shows a perspective representation of a first embodiment of a tool in a state operatively connected to a connecting means.

FIG. 6B shows another perspective representation of the tool of FIG. 6A in a state guided through an adjustment opening for adjusting a mounted window lifter assembly.

FIGS. 7A and 7B show perspective side views of a vehicle door with the proposed vehicle door assembly.

FIG. 7C shows a top view from the wet-space side onto a door inner skin of the vehicle door of FIGS. 7A and 7B with a schematic representation of a tool channel.

FIG. 8 shows a top view from the wet-space side onto a door inner skin of another vehicle door.

FIG. 9A shows a perspective representation of another embodiment of the proposed fixture.

FIG. 9B shows the proposed fixture of FIG. 9A in a state mounted on a door module carrier with a window lifter assembly mounted on the fixture.

FIG. 10 shows a flow diagram of the proposed mounting method.

FIGS. 11 and 12 show flow diagrams of the proposed method for adjusting a window lifter assembly.

### DETAILED DESCRIPTION

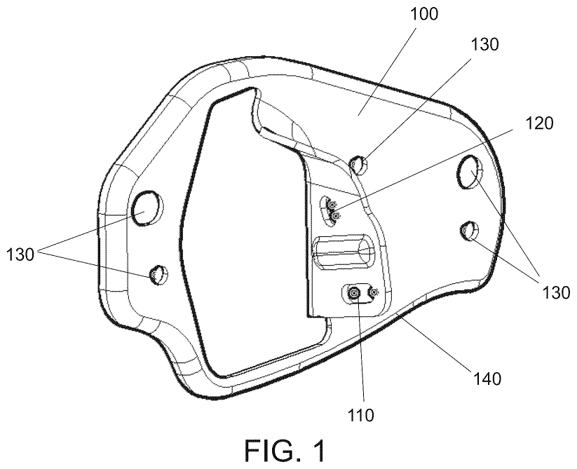

FIG. 1 shows a fixture 100 including a substantially flat base body. In a central region, the fixture 100 comprises a bent lug which includes a mounting opening 110 formed with an oblong hole. For mounting a window lifter assembly 200 on the fixture 100, a connecting element 210 can be introduced into the mounting opening 110. Above the mounting opening 110, a tool interface 120 formed with an oblong hole is arranged. The tool interface 120 has a longitudinally extending axis which extends through an imaginary center of the mounting opening 110. Furthermore, a plurality of connecting openings 130 of various sizes is incorporated into the fixture 100. Via at least some of the connecting openings 130, the fixture 100 can be mounted on a door module carrier 310. It is likewise conceivable and possible that with some of the connecting openings 130 the fixture 100 can be connected to a door inner skin 510 and/or a door trim and/or a door outer skin.

At an edge extending around the outside of the fixture 100, the same has a bent edge with which the fixture 100 can be supported on a corresponding contour of a door module carrier 310. Thus, the bent edge of the fixture 100 shown in FIG. 1 is a holding portion 140. Such a holding portion 140 simplifies the positioning of the fixture 100 on a door module carrier 310.

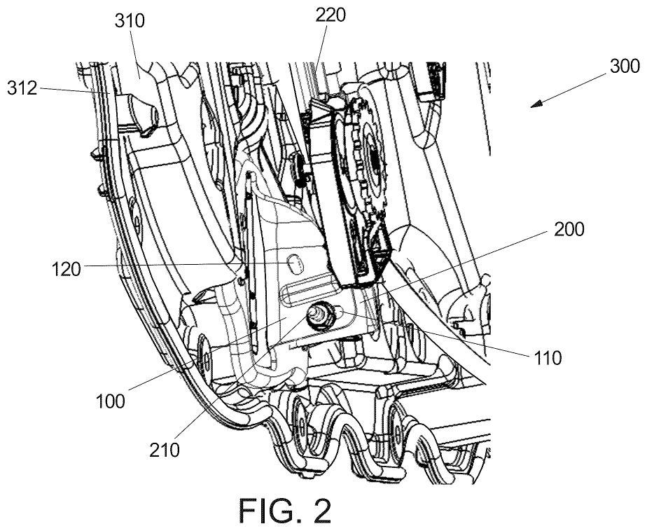

FIG. 2 shows how the fixture 100 shown in FIG. 1 supports on a door module carrier 310 via the holding portion 140. The bent edge of the fixture 100 therefor flatly rests against a corresponding contour of the door module carrier 310. For producing a connection to the door module carrier 310, the fixture 100 furthermore is connected to the same via the connecting opening 130 of the fixture 100. A connecting element 210 formed with a screw and a nut extends through the mounting opening 110 of the fixture 100. Via the connecting element 210, a window lifter assembly 200 is fixed on the fixture 100. By releasing the screw, the connecting element 210 and thus the window lifter assembly 200 can be adjusted along the mounting opening 110 and thus transversely to the door module carrier 310 into various mounting positions and can be fixed again by newly tightening the screw. Thus, the window lifter assembly 200 shown in FIG. 2 can be adjusted relative to the fixture 100 and the door module carrier 310. To shift the window lifter assembly 200 in the mounting opening 110, an adjusting force can be introduced into the connecting element 210 after releasing the screw, in that a tool 400 adapted therefor supports on the tool interface 120 of the fixture 100.

For realizing a modular solution, the window lifter assembly 200 can be mountable on different door module carriers 310 via a plurality of different embodiments of the proposed fixture 100, 101, 102, 103, 104, 105.

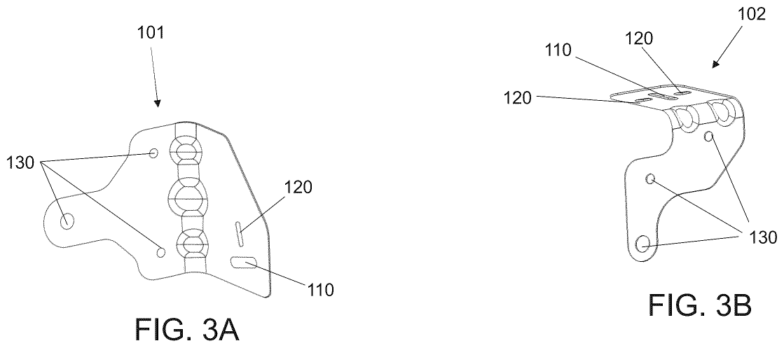

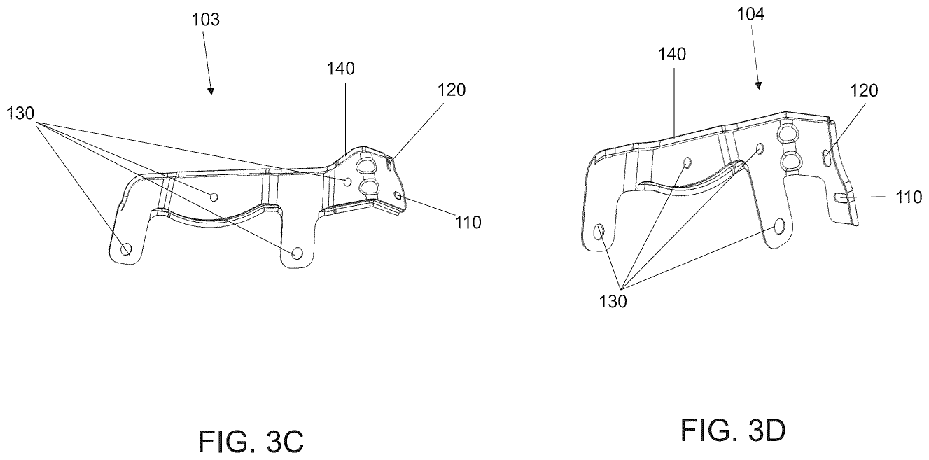

For this purpose, FIGS. 3A, 3B, 3C and 3D show various embodiments of the proposed fixture 101, 102, 103, 104, 105. The fixtures 102, 103 shown in FIGS. 3A and 3B, in contrast to the fixture 100 shown in FIG. 1, do not have a bent edge. Likewise, a number of connecting openings 130 is different. Both the embodiment of FIG. 3A and the embodiment of FIG. 3B substantially is formed as a bracket whose legs include a 90° angle. In the region of the curvature, both fixtures 101, 102 include reinforcements.

In contrast to the embodiments of FIGS. 1 and 3A, the fixture 104 in FIG. 3D includes two tool interfaces 120. Thus, the tool 400 can be used for releasing and shifting the connecting element 210 in different positions on the fixture 104.

Just like the embodiment shown in FIG. 1, the embodiments of the proposed fixture 103, 104 as shown in FIGS. 3C and 3D also have bent edges or holding portions 140. In contrast to the embodiment of the fixture 100 as shown in FIG. 1, the bent edges of the embodiments in FIGS. 3C and 3D on the other hand are not circumferential, but each extend only along a portion of the edge. Analogously to the embodiments of FIGS. 3A and 3B, the fixtures 103, 104 in FIGS. 3C and 3D each include an angled portion which is stiffened in the region of the curvature.

To provide for pushing a connecting element 210 into the mounting opening 110 without completely releasing the connecting element 210, the mounting opening 110 can have an opening 150 on a boundary.

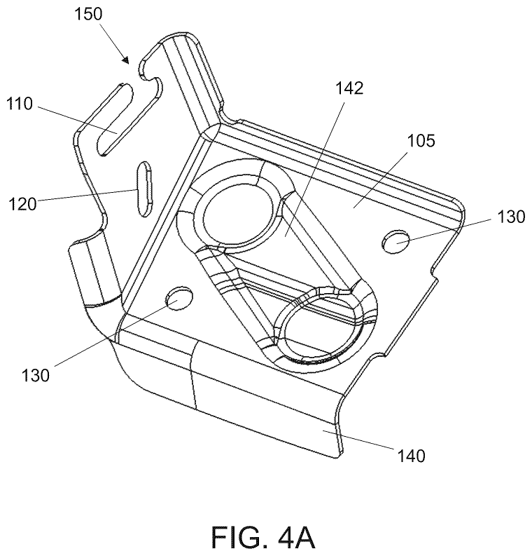

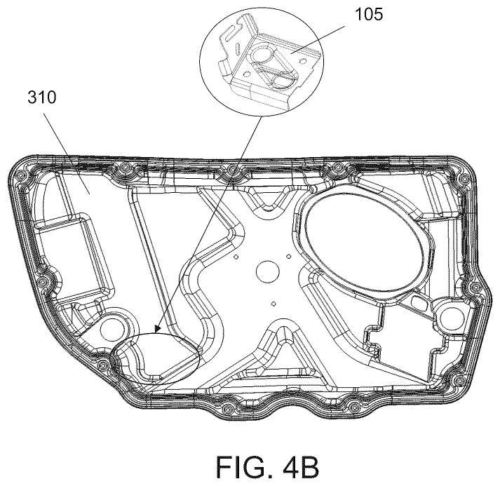

FIG. 4A therefor shows an exemplary configuration of another embodiment of the proposed fixture 105. In a region shown on the left in FIG. 4A, the same includes a mounting opening 110 whose boundary is formed with an opening 150 in the upper region, which extends up to the edge of the fixture 105. Thus, a not completely released connecting element 210, such as a screw with an attached nut, can be pushed into the mounting opening 110 and subsequently be shifted in the mounting opening 110. Analogously to the further embodiments of the proposed fixture 100, 101, 102, 103, 104 from FIGS. 1, 3A, 3B, 3C and 3D, the fixture 105 in FIG. 4A also includes connecting openings 130 for connecting the fixture 100, 101, 102, 103, 104, 105 to a door module carrier 310 and a tool interface 120 for supporting a tool 400. A holding portion 142 formed with a bead is centrally incorporated into the embodiment shown in FIG. 4A. In a state properly mounted on a door module carrier 310, the same engages into a corresponding depression of the module carrier in order to position the fixture 105. Furthermore, the embodiment of FIG. 4A also includes a holding portion 140 formed with an angled edge at a lower end.

FIG. 4B shows a proper mounting position of the fixture 105 of FIG. 4A on a door module carrier 310.

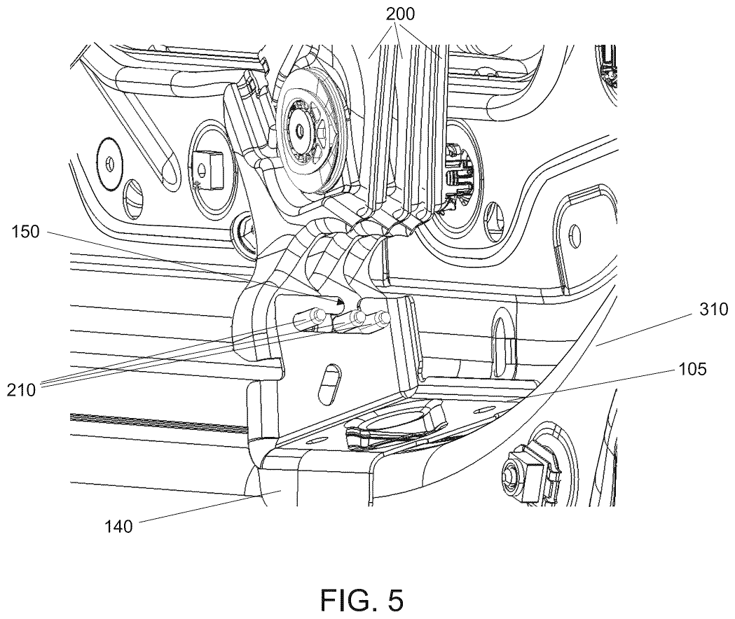

In FIG. 5 it is shown how mounting of a window lifter assembly 200 in various mounting positions is possible via the fixture 105 mounted corresponding to FIG. 4B. FIG. 5 here shows three different mounting positions for the window lifter assembly 200 by shifting the connecting element 210 within the mounting opening 110. For the sake of simplicity, the connecting element 210 here is each shown without an associated nut. For initially mounting the window lifter assembly 200 with a partly released connecting element 210, the connecting element 210 can be guided into the mounting opening 110 via the opening 150 shown at the upper edge of the fixture 105. Within the mounting opening 110, the mounting position can be defined by shifting and by tightening a nut not shown here.

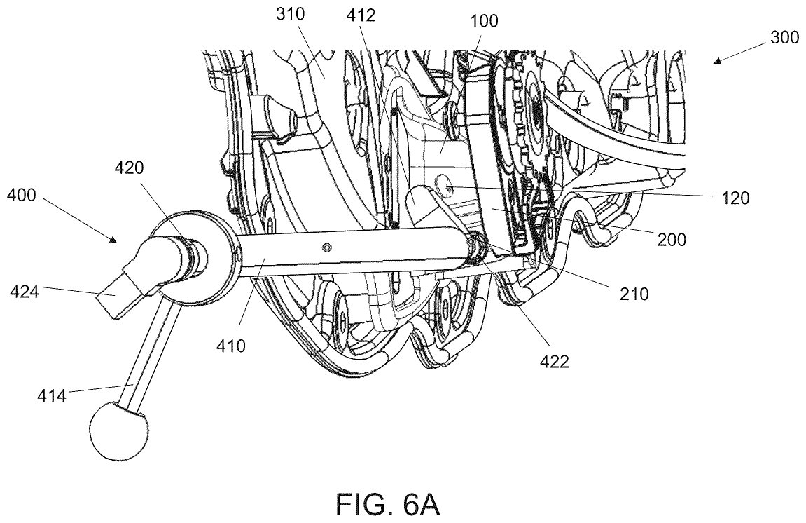

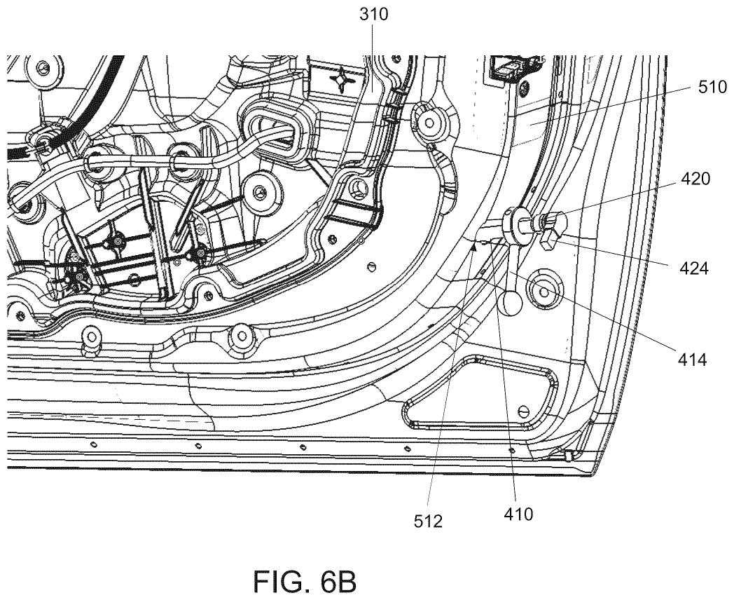

The releasing, tightening and shifting of the connecting element 210 can be carried out by means of the tool 400. For this purpose, FIG. 6A shows a first embodiment of the tool 400. The tool 400 comprises an outer element 410 and an inner element 420 rotatably mounted within the outer element 410, wherein the inner element 420 includes a tool head 422 at an end portion for releasing a connecting element 210 by a rotation. FIG. 6A shows the tool head 422 in operative connection with the connecting element 210. At an end portion opposite the tool head 422, the inner element 420 includes a handle 424 for introducing a torque into the inner element 420. Thus, by turning the handle 424, the connecting element 210 which extends through the mounting opening 110 of the fixture 100 can be released. Furthermore, the tool 400 includes a radially extending supporting portion 412 at an end portion of the outer element 410 facing the tool head 422. The tool 400 thereby can be supported on a workpiece. On an end portion facing away from the workpiece, the outer element 410 includes a handle 414 for introducing a torque into the outer element 410. By introducing the torque with the connecting element 210 at least partly released, the connecting element 210 can be shifted along the mounting opening 110, wherein the tool 400 supports on the tool interface 120. The window lifter assembly 200 mounted on the fixture 100, which is shown in FIG. 6A, thereby can be shifted relative to the door module carrier 310, and the window lifter assembly 200 thus can be adjusted.

Due to the cylinder-shaped tool 400, no manual contact with the proposed fixture 100, 101, 102, 103, 104, 105 is necessary. In this connection, FIG. 6B shows how the tool 400 provides for adjusting the mounted window lifter assembly 200 by means of the tool 400. The tool 400 therefor is guided through an adjustment opening 512 in the door inner skin 510, which provides for access to the fixture 100, 101, 102, 103, 104, 105 for the tool 400. An interior door trim not shown in FIG. 6B is irrelevant for the adjustment operation with the tool 400 and can be mounted in advance or remain mounted. The adjustment opening 512 shown in FIG. 6B accordingly provides for a linear access from the adjustment opening 512 to the mounting opening 110 and the tool interface 120.

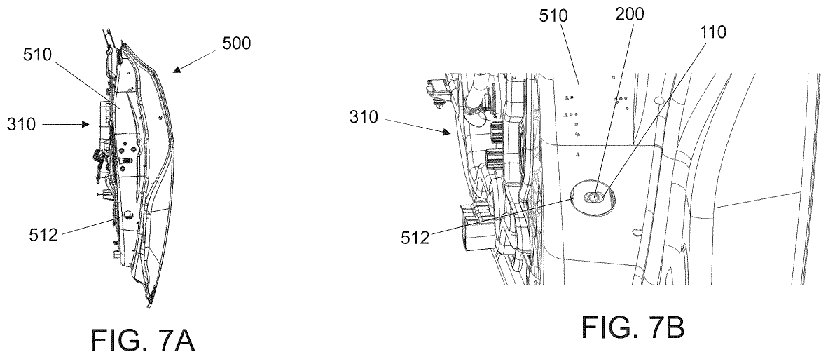

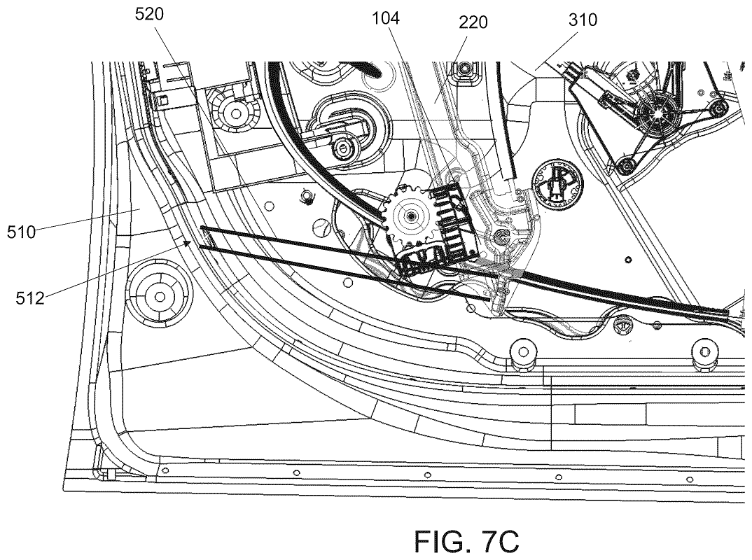

FIGS. 7A and 7B show a perspective side view of the vehicle door 500 of FIG. 6B with a view through the adjustment opening 512 onto the mounting opening 110. For reasons of clarity, a representation of the connecting element 210 in the mounting opening 110 has been omitted. Through the adjustment opening 512 and the mounting opening 110 the window lifter assembly 200 located behind the same can be seen, which can be mounted with the connecting element 210 and can be shifted along the mounting opening 110.

FIG. 7C shows a wet-space-side view of the door module carrier 310 mounted on the door inner skin 510. An imaginary connection between the adjustment opening 512 in the door inner skin 510 and the fixture 104 mounted on the door module carrier 310, which is shown in FIG. 3D, defines the tool channel 520 along which the tool 400 is guided for adjusting the mounted window lifter assembly 200.

In principle, a window lifter assembly 200 can also be mountable on a door module carrier 310 with a plurality of fixtures 100, 101, 102, 103, 104, 105. Each of the fixtures 100, 101, 102, 103, 104, 105 can include at least one connecting element 210, via which the window lifter assembly 200 can be adjusted relative to the module carrier. The fixtures 100, 101, 102, 103, 104, 105 can provide for an adjustment along respectively different spatial directions or also along the same spatial directions.

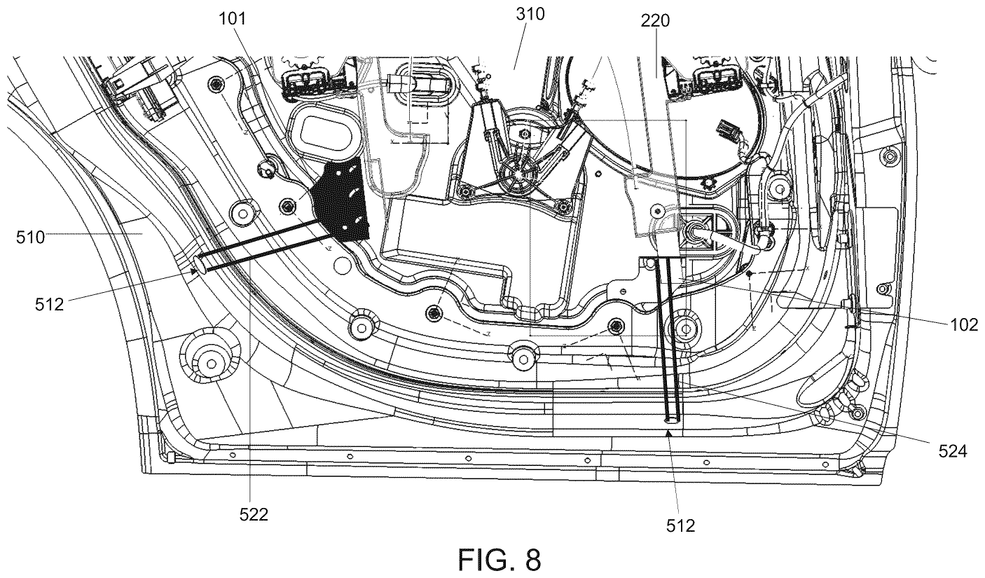

FIG. 8 shows an exemplary embodiment of a door module carrier 310 of the proposed door assembly mounted on a door inner skin 510, comprising two fixtures 101, 102 of the proposed type. Each of the fixtures 101, 102 can be reached with the tool 400 via a separate adjustment opening 512 in the door inner skin 510, in order to adjust the window lifter assembly 200 relative to the door module carrier 310. The fixture 101 shown on the left in FIG. 8 corresponds to the fixture 101 of FIG. 3A. The fixture 102 shown on the right in FIG. 8 corresponds to the embodiment shown in FIG. 3B. Both fixtures 101, 102 can be reached via the tool 400, without removing a possibly mounted interior door trim or further door components. Merely possible closures of the adjustment openings 512 shown here must be removed for introducing the tool 400.

In further embodiments of the proposed fixture 106 it is also conceivable that the mounting opening 110 is formed as a round hole.

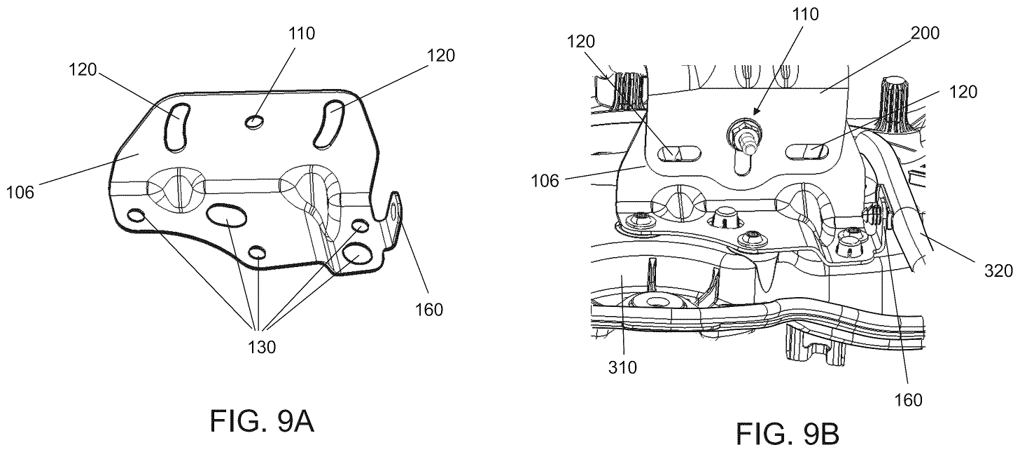

FIGS. 9A and 9B therefor show a possible embodiment of the proposed fixture 106. FIG. 9A shows the fixture 106 individually, while in FIG. 9B the fixture 106 is mounted on a door module carrier 310. On the mounted fixture 106 a window lifter assembly 200 in turn is mounted. A connecting element 210 extends through the mounting opening 110, which connects the window lifter assembly 200 to the fixture 106. To allow the window lifter assembly 200 and the fixture 106 to be shifted relative to each other, the connecting element 210 extends through an oblong hole on the side of the window lifter assembly 200. The window lifter assembly 200 likewise includes openings which are at least partly aligned with the tool interfaces 120 of the fixture 106. Thus, a supporting portion 412 of the tool 400, which is formed with a trunnion, can extend through both the tool interface 120 and the aligned opening of the mounted window lifter assembly 200. When a torque is introduced into the tool 400 operatively connected to the connecting element 210 via the tool head 422, the tool 400 is supported on the connecting element 210 and an adjusting force is introduced into the window lifter assembly 200 via the opening of the window lifter assembly 200 aligned with the tool interface 120. In the arrangement shown in FIG. 9B, the window lifter assembly 200 thus can be adjusted with regard to a distance to the door module carrier 310 via the tool 400.

Furthermore, the fixture 106 also includes a fastening portion 160. In the exemplary embodiment shown in FIGS. 9A and 9B, the fixture 106 therefor is formed with a bent lug which in the mounted state of the fixture 106 extends away from the door module carrier 310. To the fastening portion 160 a wire harness 320 of a functional part of the vehicle door 500 is attached.

In principle, the mounting portion 110 of the fixture can also be formed without a mounting opening. By way of example, the mounting portion 110 can be formed with a bolt or a screw which is integrally connected to the fixture.

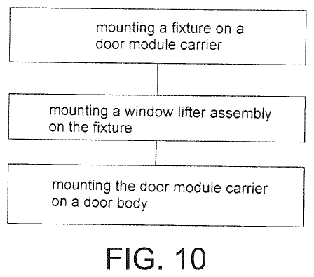

FIG. 10 shows a possible sequence of the proposed mounting method of a vehicle door assembly. Here, the fixture 100, 101, 102, 103, 104, 105, 106 initially is mounted on a door module carrier 310. Subsequently, the window lifter assembly 200 is mounted on the door module carrier 310 via the fixture 100, 101, 102, 103, 104, 105, 106 and then the door module carrier 310 is mounted on the door body. The connection of the fixture 100, 101, 102, 103, 104, 105, 106 to the door module carrier 310 by way of example is conceivable and possible by an adhesive bond, a welding connection or a screw connection.

In principle, the proposed method steps can also be carried out in a different order. By way of example, a fixture 100, 101, 102, 103, 104, 105, 106 of the proposed type initially can be mounted on a door module carrier 310. Subsequently, the door module carrier 310 can be attached to a door body in order to subsequently mount the window lifter assembly 200 on the fixture 100, 101, 102, 103, 104, 105, 106. It is likewise conceivable and possible to initially mount the door module carrier 310 on the door inner skin 510 and/or the door outer skin. Subsequently, the fixture 100, 101, 102, 103, 104, 105, 106 of the proposed type is attached to the door module carrier 310.

After mounting the window lifter assembly 200, the same in particular can be adjusted by means of the tool 400 via the adjustment opening 512 without any further disassembly.

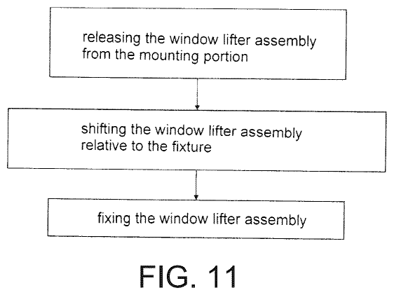

FIG. 11 therefor shows the proposed method for adjusting the mounted window lifter assembly 200. For this purpose, the window lifter assembly 200 initially is detached from the fixture 100, 101, 102, 103, 104, 105, 106 by means of a tool 400 adapted therefor, the window lifter assembly 200 is shifted from one mounting position into the other one, and subsequently the window lifter assembly 200 is fixed again. The vehicle door 500 can remain completely mounted except for the removal of possible closures for the adjustment opening 512.

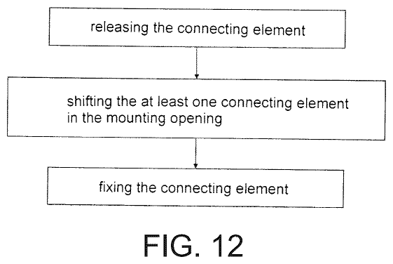

FIG. 12 shows another possible sequence of the proposed adjusting method for an embodiment of the window lifter assembly 200, in which the window lifter assembly 200 is mounted on the fixture 100, 101, 102, 103, 104, 105, 106 via a connecting element 210. For this purpose, the connecting element 210 initially is released by means of a tool, in particular the tool 400 of FIGS. 6A and 6B. Subsequently, the at least one connecting element 210 is shifted along the mounting opening 110, wherein the tool 400 supports on the tool interface 120 of the fixture 100, 101, 102, 103, 104, 105, 106. Subsequently, the at least one connecting element 210 is fixed again.

The proposed solution is not limited to the exemplary embodiments discussed here in detail. Rather, the proposed solution also comprises any combination of features of the discussed exemplary embodiments, as far as the same can be combined by the skilled person in an executable way.

### LIST OF REFERENCE NUMERALS

100, 101, 102, 103, 104, 105, 106 fixture
110 mounting portion
120 tool interface
130 connecting opening
140, 142 holding portion
150 opening
160 fastening portion
200 window lifter assembly
210 connecting element
220 guide rail
300 door module
310 door module carrier
312 sealing
320 cable strand
400 tool
410 outer element
412 supporting portion
414 handle
420 inner element
422 tool head
424 handle
500 vehicle door
510 door inner skin
512 adjustment opening
520, 522, 524 tool channel

1. A fixture for mounting a window lifter assembly in a vehicle door, wherein the fixture can be mounted in the vehicle door and at least includes:
at least one mounting portion via which the window lifter assembly can be mounted on the fixture in a plurality of mounting positions, and
at least one tool interface via which a tool adapted for connection can reversibly be connected to the fixture wherein the window lifter assembly properly mounted on the fixture can be shifted from one of the mounting positions into another one of the mounting positions by a torque introduced into the connected tool.

2. The fixture according to claim 1, wherein the mounting portion is formed with a mounting opening into which a connecting element can be introduced for mounting the window lifter assembly on the fixture.

3. The fixture according to claim 2, wherein the mounting opening is formed with an oblong hole.

4. The fixture according to claim 2, wherein a boundary of the mounting opening includes an opening for pushing the connecting element into the mounting opening.

5. The fixture according to claim 4, wherein the opening extends up to an edge of the fixture.

6. The fixture according to claim 1 wherein the tool interface is formed with a protruding or receding structure with respect to the fixture.

7. The fixture according to claim 1 wherein the tool interface is formed with an oblong hole.

8. The fixture according to claim 1, wherein the fixture includes at least one connecting opening for connecting the fixture to a door module carrier.

9. The fixture according to claim 1, wherein the fixture includes at least one holding portion protruding with respect to a flat portion of the fixture for positively connecting the fixture to a door module carrier.

10. A vehicle door assembly including:
a door module carrier,
the fixture according to claim 1 mounted on the door module carrier,
the window lifter assembly mounted on the fixture via the at least one mounting portion, and
a door body connected to the door module carrier, comprising at least one adjustment opening for adjusting the mounted window lifter assembly.

11. The vehicle door assembly according to claim 10, wherein the adjustment opening is aligned with the at least one mounting portion.

12. The vehicle door assembly according to claim 10, wherein the adjustment opening is formed in such a way that a tool adapted for adjusting the window lifter assembly can be guided through the adjustment opening.

13. The vehicle door assembly according to claim 10, wherein the adjustment opening can be closed in a waterproof way.

14. The vehicle door assembly according to claim 10, wherein the mounting portion of the fixture is formed with a mounting opening into which a connecting element can be introduced for mounting the window lifter assembly on the fixture, wherein a boundary of the mounting opening includes an opening for pushing the connecting element into the mounting opening, and the opening is arranged along a vertical above the mounting opening.

15. (canceled)

16. A method for adjusting the window lifter assembly of the vehicle door assembly according to claim 10, wherein the window lifter assembly is detached from the at least one mounting portion by means of a tool adapted for adjusting the mounted window lifter assembly the window lifter assembly is shifted from one mounting position on the fixture into another mounting position, and the window lifter assembly is fixed.

17. (canceled)
